(19) United States
(12) Patent Application Publication
(10) Pub. No.: US 2019/0152633 A1
(43) Pub. Date: May 23, 2019

(54) METHOD AND MACHINE FOR PACKAGING A FOOD PRODUCT

(71) Applicant: Chocal Aluminiumverpackungen GmbH, Schwabisch Gmund (DE)

(72) Inventors: Thomas Speck, Goggingen (DE); Joachim Scherr, Auenwald (DE); Konrad Bantleon, Gerstetten (DE); Michael Sdahl, Schorndorf (DE)

(73) Assignee: Chocal Aluminiumverpackungen GmbH, Schwabisch Gmund (DE)

(21) Appl. No.: 16/079,872

(22) PCT Filed: Feb. 24, 2017
(86) PCT No.: PCT/EP2017/054333

§ 371 Date: Jan. 29, 2019

(30) Foreign Application Priority Data
Feb. 24, 2016 (DE) 10 2016 202 814.6

(51) Int. Cl. B65B 11/50; B65B 25/00; A23G 7/00; A23G 1/54

(52) U.S. Cl. CPC B65B 11/50; A23G 1/545; A23G 7/0012; B65B 25/005

(57) ABSTRACT

The present invention refers to a method and a machine for packaging a food product by means of foil-type half-shells, wherein the foil-type half-shells are trimmed before being loaded with the food product, the trimming unit for trimming foil-type half-shells being located outside a food processing unit in which food products are loaded into foil-type half-shells.

### BACKGROUND

The present invention refers to a process for packaging a food product, in particular a hollow chocolate figure, according to the independent method claim. The invention also refers to a machine for packaging a food product, in particular a hollow chocolate figure, according to the independent apparatus claim.

A generic method and a corresponding device are known from DE 1 784 647. In this process, pieces of foil are positioned on mould troughs of a rotating mould plate, then pressed into the mould trough by a forming punch and formed into a half-shell. In the next step, the half-shell in the mould trough can be filled with a foodstuff and transported further in the mould trough to a joining position. In this joining position, the half-shell loaded with the foodstuff is joined together with a second half-shell to package the food. During joining, the two half-shells are pressed together in their flange regions and unwanted flange protrusions are cut off at the same time. This can lead to the unwanted introduction of cut foil residues into the packaged foodstuff.

The present invention is based on the object of improving the known method and the known device in such a way that food products, and in particular hollow chocolate figures, can be reliably and time-efficiently packaged in foil-type half-shells, while at least reducing the risk of undesired foil cut residue insertion.

### BRIEF SUMMARY OF PARTICULAR EMBODIMENTS

The above object is solved with the features of the independent method claim.

In the method according to the invention for packaging a food product, in particular a hollow chocolate figure, one of two foil-type half-shells is loaded with a food product and a foil-type half-shell loaded with the food product is assembled with a correspondingly different foil-type half-shell, so that the two assembled foil-type half-shells enclose the food product, the foil-type half-shells being cut before loading.

By trimming the foil-type half-shells before loading with a food product, it is possible to perform trimming and loading in spatially separate areas and/or separate method steps. This can significantly reduce or eliminate the risk of waste cuttings in the packaged food products.

In an advantageous embodiment, a foil-type half-shell can be formed by a lowering movement of a punch device and can also be cut by this punch device.

Forming and trimming the foil-type half-shell in a punch device allows space- and time-efficient forming and trimming of one or more foil-type half-shells simultaneously in a defined area. Furthermore, no transfer between an area of the forming of the foil-type half-shell and the trimming of the same is necessary, which increases the precision when trimming the foil-type half-shells, since during transfer processes the position of the light foil-type half-shells could be changed in an undesired manner before trimming. Forming the foil-type half-shell by a lowering movement of a punch device and trimming the foil-type half-shell by the punch device combines forming and cutting advantageously in one processing step. This also increases the cutting precision, as the foil-type half-shell is still in a very defined position shortly after forming.

Furthermore, in an embodiment a foil-type half-shell can be trimmed by the punch device while it is fixed by the punch device.

Fixing the foil-type half-shell by the punch device, which also trims the foil-type half-shell, further improves cutting precision during trimming, as unwanted slippage of the foil-type half-shell during the trimming process is prevented. The fixing of the foil-type half-shell by the punch device represents a particularly efficient and compact solution.

Ideally, a foil-type half-shell can be formed, fixed and trimmed in one processing step.

This allows a particularly efficient process with high cutting precision at the same time.

In a further embodiment, before the cut foil-type half-shells are joined, an unloaded foil-type half-shell can be placed on a loaded foil-type half-shell, in particular folded, so that the two foil-type half-shells enclose the food product.

Placing the cut foil-type half-shells one on top of the other before assembling allows checking and, if necessary, correcting the layers of the two foil-type half-shells relative to each other, which improves the quality of the assembled foil-type half-shells and their appearance. An optional stacking by folding the unloaded foil-type half-shell onto a loaded foil-type half-shell represents a surprisingly reliable and fast way of bringing the two foil-type half-shells together. Surprisingly, it has been shown that especially with a folding process in connection with food products which, when loaded, protrude from one foil-type half-shell, the food products advantageously support the matching superposition of the two foil-type half-shells during the folding process. In cases where the outer contours of food products, such as hollow chocolate figures, are adapted to the inner contours of the respective foil-type half-shells, the food product centres the unloaded foil-type half-shell in a particularly advantageous manner so that it lies very precisely on the correspondingly different foil-type half-shell.

Advantageously, the foil-type half-shells can be trimmed in a trimming area and loaded and joined in a food processing area spaced from it.

Spatial separation of trimming from loading and joining reliably reduces the risk of residual cuttings entering the packaged food product.

In a further embodiment, cut foil-type half-shells can be transferred to the food processing area in one working position, from which also joined foil-type half-shells can be removed from the food processing area.

The insertion of cut foil-type half-shells and the removal of joined foil-type half-shells in the same working position allows a compact design of the food processing area, since one working position can be used for two different working processes. This also allows the use of common devices for inserting and removing the cut foil-type half-shells or the joined foil-type half-shells into or out of the food processing area.

In other possible embodiments:

a foil-type half-shell can be fixed in a die during trimming, and/or

a foil-type half-shell can be formed in a half-shell-shaped die and then trimmed in this die, and/or

foil-type half-shells can be joined together in a material-locking and/or form-fitting manner during assembly, and/or

foil-type half-shells can be loaded and joined on a station-wise rotating indexing table, and/or

the foil-type half-shells can be formed, cut, loaded with food products and joined fully automatically, and/or

a foil tape can be pulled off a foil coil fully automatically, pre-cut into foil pieces, the foil pieces can be formed and cut into foil-type half-shells in one processing step, the foil-type half-shells can be loaded with food products, placed on top of each other and joined,

the foil-type half-shell loaded with a food product can be joined together with the corresponding other foil-type half-shell by sealing and/or flanging.

The aforementioned object is further solved by a machine for packaging a food product, in particular a hollow chocolate figure, according to the independent apparatus claim.

Said machine has a trimming unit for trimming foil-type half-shells as well as a food processing unit, which has a loading device for loading foil-type half-shells with food products and a joining device for assembling foil-type half-shells loaded with food products and unloaded foil-type half-shells, so that the two assembled foil-type half-shells enclose a food product. According to the invention, the trimming unit is located outside the food processing unit.

This allows a spatially separated trimming separated from the food area and thus enables a reduction of the risk of packaging of cut waste together with the food product.

Advantageously, the machine can have a forming unit for forming foil pieces into foil- type half-shells and the forming unit and the trimming unit can be arranged in one and the same work station.

This enables space- and time-efficient forming and trimming of foil-type half-shells in a work station.

In another advantageous embodiment, the forming unit and the trimming unit can be arranged in a punch device.

This enables particularly space- and time-efficient forming and trimming of the foil-type half-shells in a punch device.

Advantageously, in an embodiment, the forming unit may have a shaping structure for pressingly forming a foil-type half-shell, and the trimming unit may have a cutting device which is arranged in the work station and/or in the punch device so as to be relatively movable relative to the shaping structure.

This allows independent movement for forming and trimming the foil-type half-shell in the work station and/or punch device.

In a variant of the invention, the shaping structure may be arranged relatively movably relative to the cutting device in such a way that a pressing forming of a foil-type half-shell causes and/or permits a relative movement of the cutting device relative to the shaping structure in the direction of the foil-type half-shell.

This ensures coordinated forming and trimming.

In an advantageous embodiment, the shaping structure can be resiliently arranged in the punch device and can be arranged in front of the cutting device in the pressing direction, so that in the case of a pressing forming of a foil-type half-shell, deflection of the shaping structure causes and/or permits the relative movement of the cutting device in the direction of the foil-type half-shell.

This enables reliable and precise trimming of the foil-type half-shell by the punch device. Furthermore, the foil-type half-shell can be fixed from the shaping structure while the cutting device trims the foil-type half-shell.

In a further variant of the invention, the food processing unit can have holding devices for holding foil-type half-shells, which are moved discontinuously through the food processing unit during operation of the machine, preferably on an indexing table. In this case, two holding devices may be arranged so as to be relatively movable relative to one another and may hold foil-type half-shells in a first state during operation and in a second state a holding device may have placed its foil-type half-shells on the foil-type half-shells of the correspondingly different holding device so that the two foil-type half-shells enclose the food product.

The holding devices allow the two foil-type half-shells to be placed one on top of the other. In addition, the second state enables and facilitates monitoring of the accuracy of fit and the position of the foil-type half-shells relative to each other before joining.

In a further embodiment, two holding devices may each be connected to each other via a folding mechanism, and the food processing unit may further comprise a folding unit which actuates the folding mechanism during operation.

This enables a surprisingly reliable and precise realisation of the stacking of the foil-type half-shells.

In another variant of the invention, the machine can also have a transfer unit which is designed to pick up cut foil-type half-shells in operation, deposit them in the food processing unit and pick up and remove foil-type half-shells from the food processing unit overlapping in time, preferably simultaneously.

This enables efficient and reliable insertion of cut foil-type half-shells into the food processing unit and also efficient and reliable removal of joined foil-type half-shells from the food processing unit with only one transfer unit. In addition, the number of foil-type half-shells in the food processing unit can be easily controlled.

Advantageously, in one embodiment the transfer unit can have two movable selective gripping devices which are spaced apart from one another, in particular constantly spaced apart from one another, one gripping device being able to selectively pick up and release foil-type half-shells and the other gripping device being able to selectively pick up and release combined foil-type half-shells.

This allows a foil-type half-shell insertion position into the food processing unit and a discharge position of joined foil-type half-shells from the food processing unit to be one and the same, saving a work station.

### BRIEF DESCRIPTION OF THE DRAWINGS

In the following, a possible embodiment of the invention, which combines at least parts of the aforementioned embodiments with each other, is explained in more detail on the basis of the following drawings.

FIG. 1 shows a schematic drawing of a machine according to the invention in a view from above,

FIG. 2 shows a schematic, lateral sectional view through a part of the machine along line A-A in FIG. 1, with shown parts of a punch device with a die unit underneath,

FIG. 3 shows a schematic side view of a part of the machine, showing a transfer unit, a waiting device, parts of a food processing unit, and a product discharge device, wherein one gripping device of the transfer unit is positioned above the waiting device and another gripping device of the transfer unit is positioned above the food processing unit,

FIG. 4 shows the view from FIG. 3 in a further state of the machine, one gripping device being positioned above the food processing unit and the other gripping device being positioned above the product discharge device,

FIG. 5 shows a schematic side view of a part of the machine, with a loading device for loading food products into foil-type half-shells in a state in which a food receiving device of the loading device is positioned above food products to be packed,

FIG. 6 shows the view from FIG. 5 in a further state, in which the food receiving device receives two food products and is in a position above a holding device for foil-type half-shells located on a part of a indexing table,

FIG. 7 shows a schematic view of a part of the machine, where a folding unit is in contact with a pair of holding devices,

FIG. 8 shows a schematic side view of a pair of holding devices, in a condition in contact with the folding unit, with unloaded foil-type half-shells of one holding device being folded straight onto loaded foil-type half-shells of the other holding device,

FIG. 9 shows the view from FIG. 8 in a further state, in which the unloaded foil-type half-shells were folded onto the loaded foil-type half-shells,

FIG. 10 shows a schematic cross-sectional view of a joining device for joining foil-type half-shells loaded with food products along line B-B of FIG. 1,

FIG. 11 shows a schematic cross-sectional view of two assembled foil-type half-shells, which contain a food product, here in the form of a symmetrical egg-shaped hollow chocolate figure,

FIG. 12 shows a schematic cross-sectional view of another possible shape of an asymmetrical hollow chocolate figure enclosed by two joined foil half-shells.

### DETAILED DESCRIPTION OF PARTICULAR EMBODIMENTS

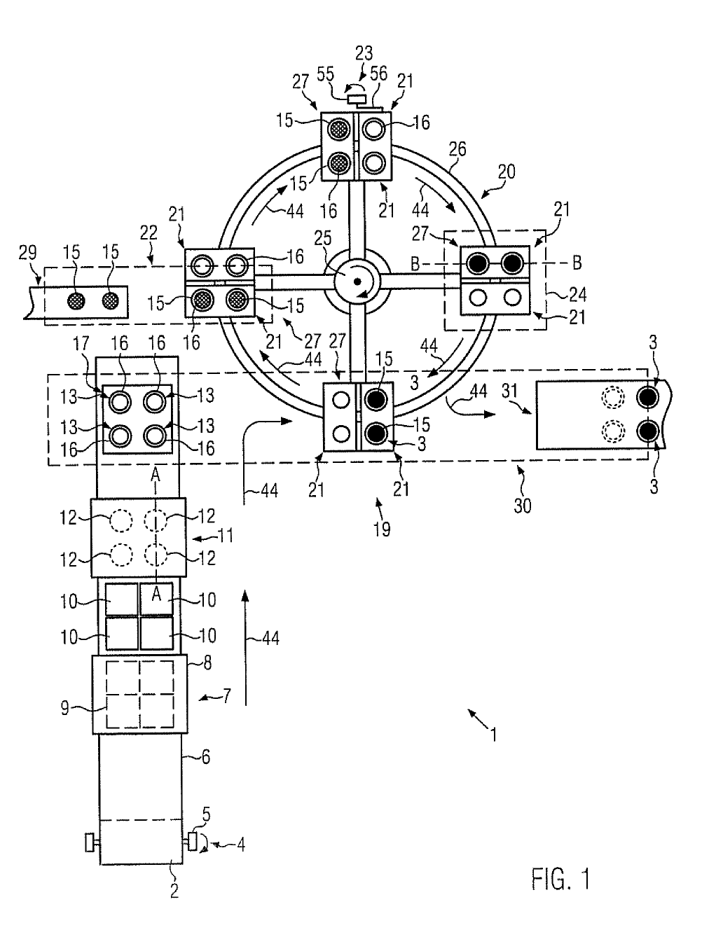

As shown in FIG. 1, machine 1 has a foil supply unit 4 at the beginning of the processing path from foil coil 2 to the assembled product 3. In the foil supply unit 4 a foil coil 2 is rotatably suspended and has a controlled drive 5. The drive 5 can drive the foil coil 2 discontinuously if necessary and support the removal of a foil tape 6 from the foil coil 2. The foil of foil coil 2 is provided on one side with a sealable layer which melts on heating and is adhesive until it cools down. Preferred thicknesses of the foil are in the range of 5 μm to 100 μm, particularly in a range of 10 μm to 50 μm, especially in a range of 15 μm to 40 μm.

The foil material used is preferably plastically deformable in the cold state. The foil material can be, for example, a metal foil, especially an aluminium foil.

An foil gripper slide construction, not shown, which can be moved back and forth in the direction of the processing path 44 of machine 1 can pull the foil tape 6 off the foil coil 2 and transport it discontinuously to a pre-cutting station 7.

The pre-cutting station 7 is arranged as the next processing unit in the direction of the processing path 44 of the foil supply unit 4.

The pre-cutting station 7 has a pre-cutting punch 8 with a pre-cutting blade 9. In the pre-cutting station 7, the foil tape 6 is cut into four foil pieces 10 per working cycle by the controlled lifting and lowering pre-cutting knife 9.

The foil pieces 10 are then moved by a not shown transfer slide with negative pressure foil grippers, which can be moved back and forth horizontally in the direction of the processing path, under a punch device 11 and placed on half-shell-shaped forming dies 12 underneath the punch device 11. Punch device 11 is arranged downstream of the pre-cutting station 7 as the next processing unit in the direction of processing path 44. For illustrative purposes, pieces of foil 10 are shown in FIG. 1 during their transport from the pre-cutting station 7 to the punch device 11.

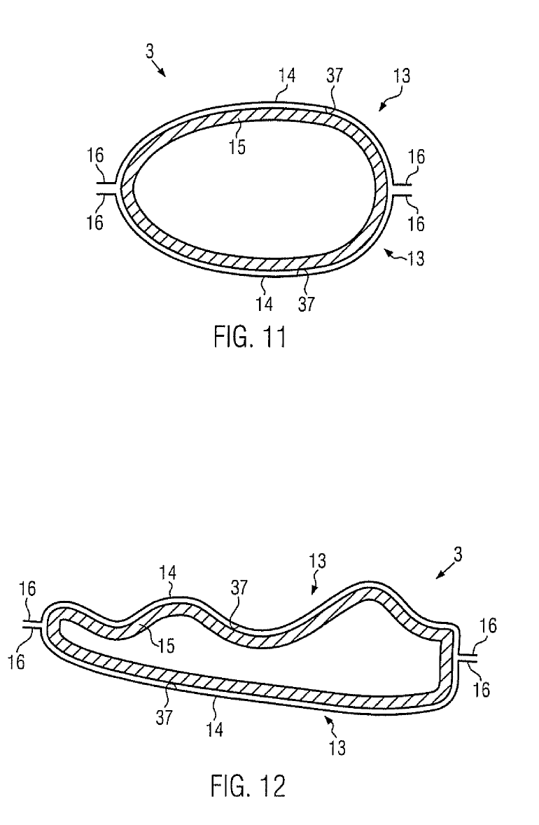

The punch device 11 now forms the foil pieces 10 into foil-type half-shells 13, fixes and cuts them further in one processing step or one working cycle. The forming dies 12 are indicated in FIG. 1 in dashed lines. After forming and trimming, each foil-type half-shell 13 has a half-shell-shaped body 14, which in this embodiment is adapted in its shape to the corresponding contour of the food product 15 to be packaged. Furthermore, each foil-type half-shell 13 has a ring-shaped foil flange 16 adjoining the half-shell-shaped body 14 and extending from the half-shell-shaped body 14 in a plane, see also FIGS. 11 and 12.

The formed and finally trimmed foil-type half-shells 13 are then removed from the forming dies 12 by means of 3D form suction cups, not shown, which are suspended on a movable slide device, not shown either, and moved via a slide device, not shown, to a waiting device 17 and deposited on this.

The waiting device 17 is arranged directly downstream of the punch device 11 in the direction of the processing path 44 and has foil-type half-shell holders 18 corresponding to the number of foil-type half-shells 13.

FIG. 1 also shows a food processing unit 19 with a indexing table 20 on which foil holding devices 21 are arranged. The food processing unit 19 also has a loading device 22, a folding unit 23 and a joining device 24. The food processing unit 19 realizes a food processing area.

Indexing table 20 rotates clockwise discontinuously during operation and in this embodiment has four pairs of two of the foil holding devices 21 (hereinafter referred to as holding devices) which can be folded on top of each other. In each case two pairs 27 of holding devices 21 lie crosswise opposite each other.

Indexing table 20 is equipped with a drive 25 in the centre, which moves the table 20 clockwise discontinuously and controlled. All four pairs of holding devices 21 are located at equal distances from each other along a circular substructure 26 of the indexing table 20. Substructure 26 is coupled in turn to drive 25 and rotates with the pairs of holding devices. The indexing table rotates the respective holding device pair 27 by 45° to a subsequent machining position. The machining positions are hereinafter referred to as six o'clock, nine o'clock, twelve o'clock and three o'clock positions.

Each holding device 21 can hold two foil-type half-shells 13 by means of corresponding holders 28.

A pair of holding devices 27 is shown in a six o'clock working position of the indexing table 20, whereby only the holding device 21 following in clockwise direction has foil-type half-shells 13, here in each case two joined foil-type half-shells, which house a food product 15. The six o'clock position represents the next processing unit to the waiting device 17.

In a nine o'clock position of the indexing table 20, indicated by dashed lines, the loading device 22 is shown. As can be seen, the loading device 22 spans a holding device 21 in the nine o'clock position into which food products 15 are to be inserted. Furthermore, the loading device spans parts of a food product feeding device 29. The spanned holding device 21 holds two foil-type half-shells 13, each loaded with a food product 15. The nine o'clock position of the indexing table 20 together with the loading device 22 represents the next processing unit to the six o'clock position.

In a twelve o'clock position there is a pair of holding devices 27 at the level of the folding unit 23. The shown holding device 21 following in clockwise direction contains two foil-type half-shells 13, both of which are each equipped with a food product 15. The opposite other holding device 21 contains two unloaded foil-type half-shells 13. The folding unit 23 represents the next processing unit to the loading unit 22.

In the three o'clock position of the indexing table 20, the joining device 24 is shown only with dashed lines for the sake of clarity. Here, the foil-type half-shells 13 lying on top of each other at their flanges are pressed and sealed on top of each other. Joining device 24 represents the next processing unit to folding unit 23.

Optionally, sealing and/or flanging and/or application of flanges 13 can also take place in the joining device 24. In other embodiments, not shown, the aforementioned machining steps can be carried out in several fixtures and thus in several consecutive machining positions instead of in one joining device. Up to six machining positions for the indexing table 20 can then be available, for example.

A transfer unit 30, indicated by dashed lines in FIG. 1, spans the waiting device 17, the six o'clock position of the indexing table 20 and part of a finished product removal device 31.

With the aid of transfer unit 30, the finished product removal device 31 removes the assembled foil-type half-shells 13, which house a food product, from the six o'clock position of indexing table 20 and thus from food processing unit 19 and transfers them, for example, to a storage area not shown.

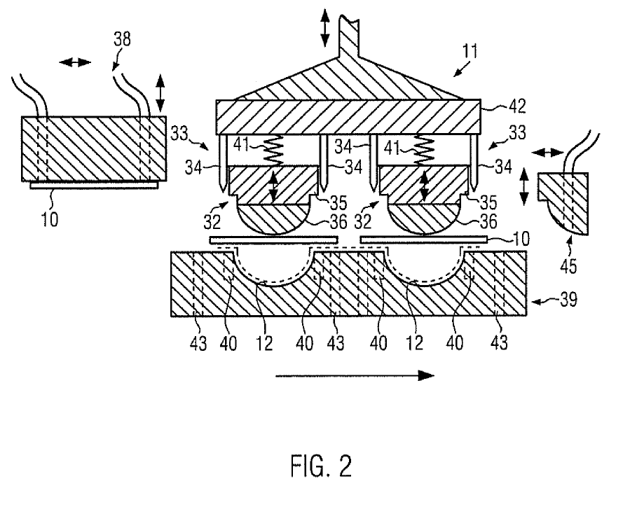

FIG. 2 shows the punch device 11, here with two identical forming units 32 for forming foil-type half-shells 13 and correspondingly two associated trimming units 33 for trimming formed foil-type half-shells 13.

Only one of the two combinations of forming unit 32 and trimming unit 33 is described in more detail below. The trimming unit 33 has a cutting device 34 with a product-dependent contour, here in the form of a circular rotating knife. The cutting device 34 is thus arranged here in its cylindrical form and with its cutting end facing downwards in the opposite direction to the forming dies 12.

The forming unit 32 is guided within the cylindrical cutting device 34 by the latter. The forming unit 32 has a sliding section 35 at one end and a shaping structure 36 opposite the forming die 12 at the other, lower end.

The shaping structure 36 corresponds to the inner contour of the foil-type half shell 13. The shown foil piece 10 was positioned by the one vacuum gripper slide 38 between the shaping structure 36 and the forming die 12. In the state shown, the foil piece 10 is still unshaped and conceals the half-shell-shaped forming die 12. The forming die 12 is formed by a recess in the die unit 39. A recess 40 in the die unit 39 is formed concentrically around the forming die 12 and is indicated here in dashed lines.

The sliding section 35 of the forming unit 32 is guided in a sliding manner in the cutting device 34 and resiliently connected to a superstructure 42 of the movable punch device 11 via an elastic element 41, for example a spring. The cutting device 34 is rigidly connected to the superstructure 42.

The die unit 39 also has suction devices 43, which are indicated here in dashed lines. These suction devices reliably suck off any foil cut residues by means of vacuum. In the state shown in FIG. 2, the punch device 11 moves straight in the direction of the forming dies 12 to form foil-type half-shells 13 from the foil pieces 10.

The direction of the processing path of the machine is indicated here by an arrow 44. 3D form suction cups 45 are indicated in the direction of processing path 44. These form suction cups 45 are controllably movable both horizontally and vertically and can pick up the formed foil-type half-shells, which are indicated by dashed lines in the forming dies 12, by using vacuum from the forming dies 12 and move them to the waiting device 17 and finally deposit them there.

A part of the slide 38 is arranged upstream of the processing path 44, which can transport the pre-cut foil sections 10 from the pre-cutting station 7 to the punch device 11 by means of negative pressure. The slide 38 can also be moved vertically and horizontally.

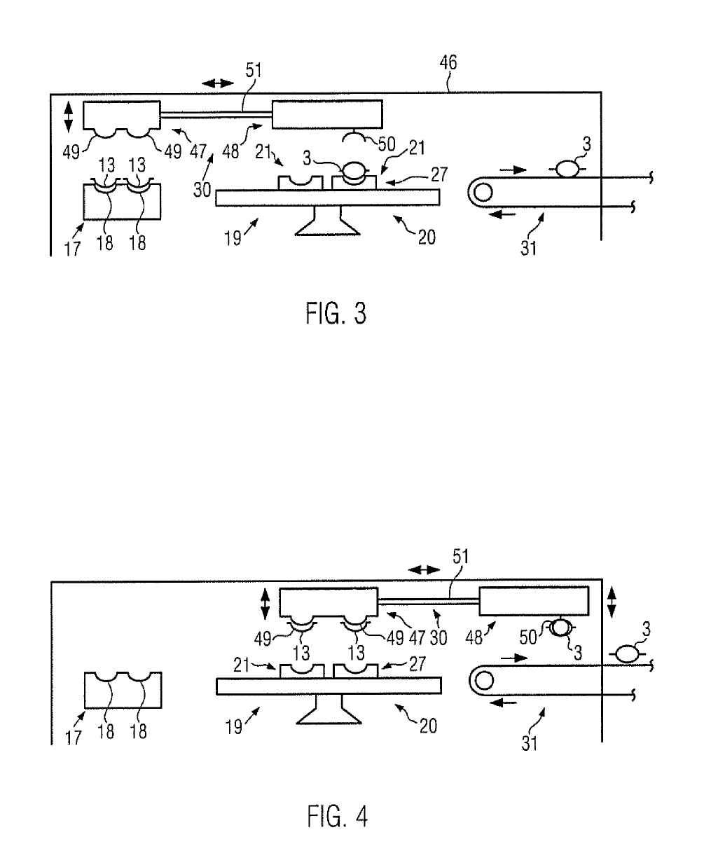

FIG. 3 shows the movable and controllable transfer unit 30, which is movably arranged horizontally and vertically along a rail system 46 spanning the waiting device 17, the six o'clock position of the indexing table 20 and parts of the product discharge device 31. The transfer unit 30 has a selective gripping device 47, 48 at each of its two opposite ends.

One gripping device 47 is set up via convex 3D form suction cups 49 to pick up formed foil-type half-shells 13 from the waiting device 17 and deposit them in the six o'clock position of the indexing table 20. The other gripping device 48 is equipped with a concave 3D form suction cup 50 to pick up assembled foil-type half-shells 3, which contain a food product 15, from the six o'clock position of the indexing table 20 and deposit them in the product discharge device 31. The two gripping devices 47, 48 are firmly connected to each other via a rigid slide structure 51. In other embodiments, not shown, the gripping devices 47, 48 can move freely relative to each other and can be controlled separately in their movements. Each gripping device 47, 48 also has a moving part, not shown, which allows the convex or concave suction devices 49, 50 to move vertically.

FIG. 4 shows how the convex suction devices moved 49 foil-type half-shells 13 over the six o'clock position of the indexing table 20 and simultaneously picked up the concave suction devices 50 completely assembled foil half-shells, i.e. the end product 3, and moved them over the product discharge device 31.

One gripping device 47 has a total of four convex suction devices 49 and the other gripping device 48 has a total of two concave suction devices 50. Due to the lateral perspective, only two convex and one concave suction device can be seen. The product discharge device 31 is a conveyor belt.

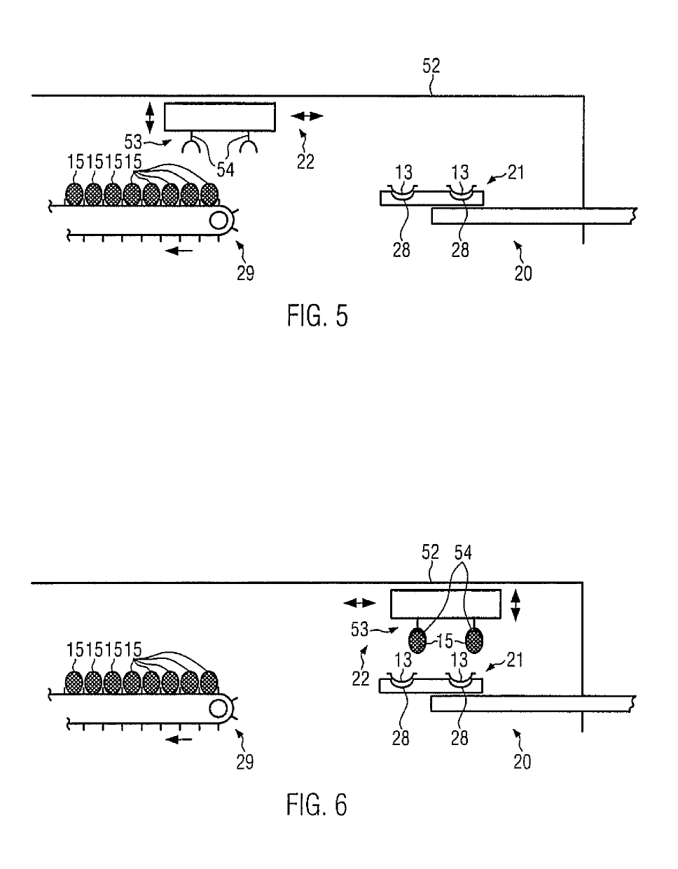

FIG. 5 shows the loading device 22 with the food receiving device 53 guided on a rail system 52. The rail system 52 of the device spans parts of the food product feeding device 29 in the form of a conveyor belt as well as the nine o'clock position of the indexing table 20. The food receiving device 53 is movably arranged vertically and horizontally guided on the rail system 52. The food receiving device 53 comprises two concave suction devices 54, which can receive food products 15 and place them in the two illustrated foil-type half-shells 13 of the holding device 21 located at the 9 o'clock position of the indexing table 20.

FIG. 6 shows the loading device 22 as the food receiving device 53 has picked up two food products and moved them to a position above the foil-type half-shells 13.

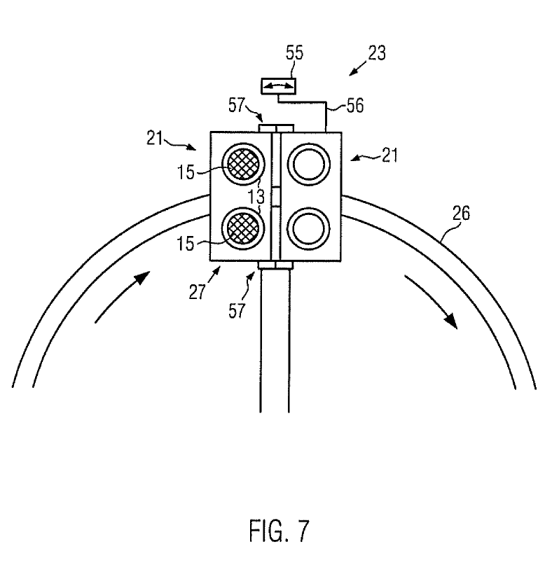

The folding unit 23 in FIG. 7 comprises a controllable drive 55 with a rotatable, S-shaped swivel arm 56, which selectively couples to the holding device 21 comprising the unloaded foil-type half-shells 13 and can transfer this into a folding position as well as into the starting position shown in this Figure by a controlled rotation of the swivel arm 56.

The holding devices 21 of the holding device pairs 27, each of which is arranged clockwise, are permanently connected to the indexing table 20. The respective other holding devices 21 are movably arranged to the indexing table 20. The two holding devices 21 of a pair 27 are connected by a folding mechanism 57 in the form of two hinges.

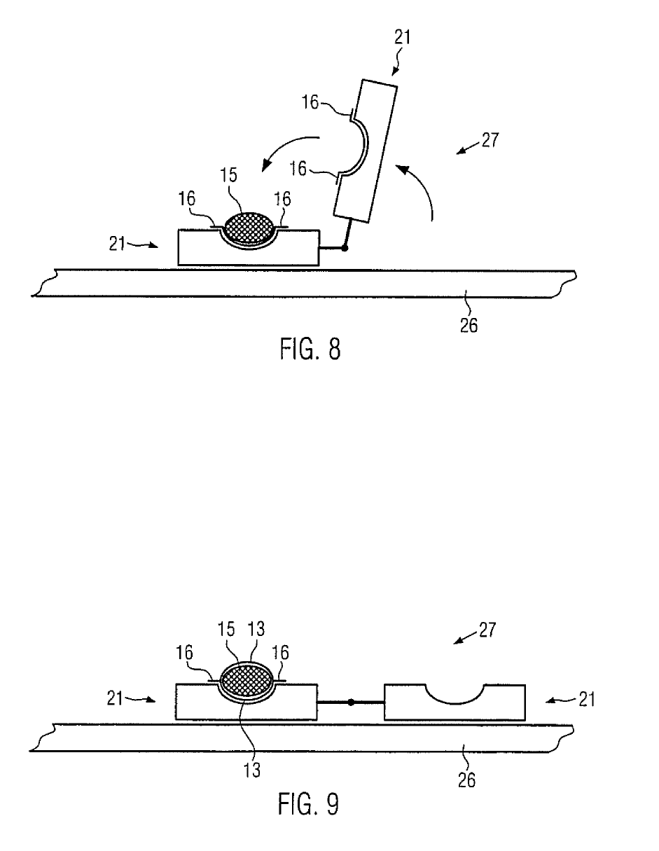

The swivel arm 56 of the folding unit 23 of the holding device pair 27, which is in the twelve o'clock position, reaches under the movable holding device 21 and couples selectively with it. A controlled rotary movement of the S-shaped swivel arm 56 folds the holding devices 21, which are otherwise almost in one plane, onto each other in such a way that the movable holding device 21 is folded to a certain angle via the folding mechanism 57 onto the corresponding other holding device 21. In this case, the two holding devices 21 do not have to touch, as the foil-type half-shells 13 of the movable holding device 21 are guided through the protruding food products 15 to the correct position. As can be seen clearly in FIGS. 8 and 9, after a folding process by the folding unit 23 the flanges 16 of the two foil-type half-shells 13 lie flush and in alignment on top of each other. The precise alignment of the superimposed foil-type half-shell flanges 16 makes further re-cutting of the flanges 16 (contour re-cutting) superfluous.

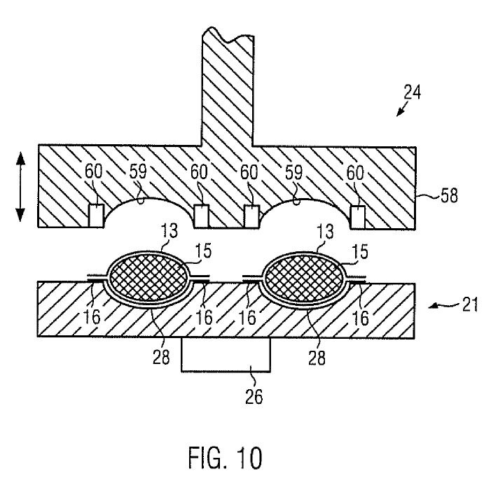

FIG. 10 shows the joining device 24 with a vertically movable upper punch 58, as well as a holding device 21 located in the three o'clock position of the indexing table 20, in which two foil-type half-shells 13 lie flush and aligned with their flanges 16, so that the food product 15 is enclosed between and from them. The upper punch 58 has recesses 59 corresponding to the outer contour of the formed foil-type half-shells 13. The recesses 59 are each surrounded at their edges by annular heating elements 60, which are arranged according to the foil-type half-shell flanges 16. During joining, the upper punch 58 is pressed vertically downwards against the holding device 21 until the foil-type half-shell flanges 16 are pressed between the upper punch 58 and the holding device 21. The heating elements 60 are then heated until the sealable layer bonds the flanges 16 together or the food product 15 is hermetically sealed.

FIG. 11 shows the schematic cross-sectional view of a food product 15 in the form of a hollow chocolate figure enclosed between two foil-type half-shells 13. The sealed flanges 16 protrude in a Saturn ring-like manner in the equatorial plane of the symmetrical chocolate egg 15 enclosed here.

FIG. 12 shows another hollow chocolate FIG. 15 with an asymmetrical profile. In such a case, two different foil-type half-shell shapes 13 are formed in the punch device 11. Accordingly, the recesses 59 for the foil-type half-shells 13 in the holding devices 21 are correspondingly adapted to the different half-shell profiles.

It is pointed out that the method described here and the machine 1 described here are suitable for any number of foil-type half-shells 13, which represents a multiple of two, and are therefore disclosed here.

For better illustration, a method according to the invention for packaging a food product 15 using a machine 1 shown in the Figures is briefly explained below.

The foil tape 6 is taken off discontinuously from the foil coil 2, cut into four foil sections 10 in the pre-cutting station 7, which are then conveyed into the punch device 11.

In the punch device 11 the foil parts 10 are formed by a lowering movement of the punch device 11 in the direction of the forming dies 12. In this process, the shaping structure 36 comes into contact with the foil piece 10 first and presses it into the forming die 12, where the foil-type half-shells 13 and flange 16 are each formed by the shaping structure 36 and by parts of the sliding section 35.

As soon as the foil piece 10 lies flush in the forming die 12 and the shaping structure 36 can no longer move along with the downwardly lowering punch device 11, the shaping structure 36 springs in, resulting in a relative movement of the shaping structure 36 to the cutting device 34, which moves even further with the punch device 11 in the direction of the forming die 12 and cuts off protruding protrusions of the foil flange 16 over the cutting recesses 40 by retracting into the recesses 40. These cut-off protrusions are simultaneously sucked off by the suction device 43.

The punch device 11 then moves up again and the formed and finally trimmed foil-type half-shells 13 can be picked up by the 3D form suction cup 45 and transported to and deposited in the waiting device 17.

In the waiting device 17, the convex suction cups 49 of the gripping device 47 of the transfer unit 30 pick up the formed foil-type half-shells 13 and transport them to an empty holding device 21 waiting in the six o'clock position of the indexing table 20. Almost simultaneously for picking up the foil-type half-shells 13 in the waiting device 17, the concave suction cups 50 of the other gripping device 48 pick up fully assembled foil-type half-shells 13 waiting in the six o'clock position of the indexing table 20 and transport them to the product discharge device 31.

Then the indexing table 20 rotates 45° further and transports the four foil-type half-shells 13 inserted into the holding devices 21 from the six o'clock position to the nine o'clock position. In the nine o'clock position, the foil-type half-shells 13 in the fixed holding device 21 are each fitted with a food product 15.

The indexing table 20 then moves another quarter turn to the twelve o'clock position. At the twelve o'clock position, the loose holding device 21 is folded onto the fixed holding device 21. Here the loose holding device 21 is conveyed by the folding unit 23 with its swivel arm 56 into the folding position so quickly that the foil-type half-shells 13 remain in the moving holding device 21 by the acceleration and the air resistance until this is folded to its final position opposite the fixed holding device 21. The foil-type half-shells 13 are placed on the top side of the corresponding food product 15 with the foil-type half-shell 13 underneath and centered accordingly by the top side of the protruding food product 15. After folding, the now empty movable holding device 21 is moved back into its initial position by the folding unit 23 and the swivel arm 56 is decoupled from the movable holding device 21.

The indexing table 20 then rotates a quarter turn further and transfers the foil-type half-shells 13 and the internal food product 15 to the joining device 24. In the joining device 24 the upper punch 58 moves downwards and presses the superimposed flanges 16 of the foil-type half-shells 13 together and seals them by the use of heat in the heating elements 60.

Then the upper punch 58 moves up again and the indexing table 20 rotates a quarter turn (45°), back to the initial six o'clock position. The two gripping devices 47, 48 of the transfer unit 30 are again located above the waiting device 17 and the six o'clock position of the indexing table 20, so that the convex gripping devices 49 can pick up foil-type half-shells 13 from the waiting device 17 and the concave gripping devices 5 can simultaneously pick up the assembled foil-type half-shells 13/the end product 3 from the six o'clock position and transport them to the product discharge device 31.

The processes described above in the respective six o'clock, nine o'clock, twelve o'clock and three o'clock positions of the indexing table 20 can run correspondingly simultaneously, i.e. for example that while foil-type half-shells 13/ the end product 3 are removed in the six o'clock position and individual foil-type half-shells 13 are inserted, a food product 15 is loaded in the nine o'clock position, a folding takes place in the twelve o'clock position and foil-type half-shells 13 are joined in the three o'clock position.

1. Method for packaging a food product (15), in particular a hollow chocolate figure, wherein one of each two foil-type half-shells (13) is loaded with a food product (15), and a foil-type half-shell (13) loaded with the food product (15) is joined together with another corresponding foil-type half-shell (13) so that the two joined foil-type half-shells (13) enclose the food product (15), characterized in that the foil-type half-shells (13) are trimmed before loading.

2. Method according to claim 1, wherein a foil-type half-shell (13) is formed by a lowering movement of a punch device (11) and is also trimmed by said punch device (11).

3. Method according to claim 2, wherein a foil-type half-shell (13) is trimmed by the punch device (11) while fixed by the punch device (11).

4. Method according to one of the preceding claims claim 1, wherein a foil-type half-shell (13) is formed, fixed and trimmed in a single machining operation.

5. Method according to one of the preceding claims claim 1, wherein before the cut foil-type half-shells are joined together, an unloaded foil-type half-shell is placed, in particular folded, on a loaded foil-type half-shell so that the two foil-type half-shells enclose the food product.

6. Method according to one of the preceding claims claim 1, wherein the foil-type half-shells (13) are trimmed in a trimming area (11) and are loaded and joined together in a food processing area (19) spaced therefrom.

7. Method according to claim 6, wherein cut foil-type half-shells (13) are transferred into the food processing area (19) in a working position from which also joined foil-type half-shells (13) are removed from the food processing area (19).

8. Machine (1) for packaging a food product (15), in particular a hollow chocolate figure, comprising a trimming unit (33) for trimming foil-type half-shells (13), and a food processing unit (19) comprising a loading device (22) for loading food products (15) into foil-type half-shells (13) and a joining device (24) for joining together foil-type half-shells (13) loaded with food products (15) and unloaded foil-type half-shells (13) so that the two joined foil-type half-shells (13) enclose a food product (15), characterized in that the trimming unit (33) is arranged outside the food processing unit (19).

9. Machine (1) according to claim 8, the machine (1) comprising a forming unit (32) for forming foil pieces (10) into foil-type half-shells (13), and the forming unit (32) and the trimming unit (33) being arranged in one and the same work station.

10. Machine (1) according to claim 9, wherein the forming unit (32) and the trimming unit (33) are arranged in a punch device (11).

11. Machine according to claim 9, wherein the forming unit (32) has a shaping structure (36) for pressingly forming a foil-type half-shell (13), and the trimming unit (33) has a cutting device (34) which is arranged in the work station and/or in the punch device (11) so as to be relatively movable relative to the shaping structure (36).

12. Machine (1) according to claim 11, wherein the shaping structure (36) is arranged to be relatively movable relative to the cutting device (34) such that a pressing forming of a foil-type half-shell (13) causes and/or permits a relative movement of the cutting device (34) relative to the shaping structure (36) in the direction of the foil-type half-shell (13).

13. Machine (1) according to claim 12, wherein the shaping structure (36) is resiliently arranged in the punch device (11) and is arranged in a leading position to the cutting device (34) in the pressing direction, so that, when a foil-type half-shell (13) is formed by pressing, a deflection of the shaping structure (36) causes and/or permits the relative movement of the cutting device (34) in the direction of the foil-type half-shell (13).

14. Machine (1) according to one of claims 8 to 13 claim 8, wherein the food processing unit (19) comprises holding devices (21) for holding foil-type half-shells (13) which are moved discontinuously through the food processing unit (19) during operation of the machine (1), preferably on a indexing table (20), and wherein two holding devices (21) are each arranged so as to be relatively movable relative to one another and hold foil-type half-shells (13) in a first state during operation and in a second state a holding device (21) has placed its foil-type half-shells (13) on the foil-type half-shells (13) of the correspondingly other holding device (21) so that the two foil-type half-shells (13) enclose the food product (15).

15. Machine (1) according to claim 14, wherein two holding devices (21) are each being connected to each other by a folding mechanism (57), and the food processing unit (19) further comprises a folding unit (23) which actuates the folding mechanism (57) during operation.

16. Machine (1) according to one of claims 8 to 15 claim 8, wherein the machine (1) comprises a transfer unit (30) which is adapted to receive foil-type half-shells (13) cut in operation and to deposit them in the food processing unit (19) and, overlapping in time, preferably simultaneously, to receive and remove joined foil-type half-shells (13) from the food processing unit (19).

17. Machine (1) according to claim 16, wherein the transfer unit (30) comprises two movable selective gripping devices (47, 48) which are spaced apart from one another, in particular are constantly spaced apart from one another, wherein one gripping device (47) can selectively receive and discharge foil-type half-shells (13), and the other gripping device (48) can selectively receive and discharge joined together foil-type half-shells (13, 3).
